(19) United States
(12) Patent Application Publication
(10) Pub. No.: US 2026/0153395 A1
(43) Pub. Date: Jun. 4, 2026

(54) DETECTION DEVICE

(71) Applicant: Magnolia White Corporation, Tokyo (JP)

(72) Inventors: Fumihoru NAKANO, Tokyo (JP); Toshinori UEHARA, Tokyo (JP); Masatomo HISHINUMA, Tokyo (JP)

(21) Appl. No.: 19/179,422

(22) Filed: Apr. 15, 2025

(30) Foreign Application Priority Data
Apr. 22, 2024 (JP) 2024-069156

(51) Int. Cl. G01L 5/1627; G01L 1/22

(52) U.S. Cl. CPC G01L 5/1627; G01L 1/2262

(57) ABSTRACT

A detection device includes a substrate that is flexible, and a bridge circuit disposed within the substrate. A first resistance element, a second resistance element, a third resistance element, and a fourth resistance element are connected in series in an order from the first to fourth resistance elements to constitute the bridge circuit in a closed loop shape. The first resistance element is an expandable and contractable resistance element that has a first part and a second part connected in series. Each of the second resistance element, the third resistance element, and the fourth resistance element is a non-expandable and non-contractable resistance element. The first part and the second part of the first resistance element are provided in different layers of the substrate, overlapped with each other in a length direction in a planar view, and disposed in parallel to each other.

### BACKGROUND OF THE INVENTION

### CLAIM OF PRIORITY

The present application claims priority from Japanese Patent Application JP 2024-69156 filed on Apr. 22, 2024, the content of which is hereby incorporated by reference into this application.

### 1. Field of the Invention

The present disclosure relates to a detection device.

### 2. Description of the Prior Art

For example, JP 2019-90723 A proposes a strain gauge which includes a Wheatstone bridge circuit.

### Prior Art Document

### Patent Document

Patent document 1: JP 2019-90723 A

A stretchable device is required to handle not only bending but also complicated movement such as expansion and contraction, and twists. The present disclosing party considers a following point essential for this type of stretchable device. A sensor which senses movement of skin by using a stretchable sensor attached to a human body (e.g., the back of the hand) recognizes both a signal indicating expansion and contraction strain and a signal indicating bending strain as amplifier outputs. For detecting only expansion and contraction strain, a bending strain component needs to be cancelled out from a detection signal.

### SUMMARY OF THE INVENTION

An object of the present disclosure is to provide a technology capable of separating strain into expansion and contraction strain and bending strain.

Other problems and novel characteristics will become apparent from the description of the present specification and the accompanying drawings.

A summary of typical aspects of the present invention will be hereinafter briefly described.

Specifically, a detection device includes: a substrate that is flexible; and a bridge circuit disposed within the substrate. A first resistance element, a second resistance element, a third resistance element, and a fourth resistance element are connected in series in an order from the first to fourth resistance elements to constitute the bridge circuit in a closed loop shape. The first resistance element is an expandable and contractable resistance element that has a first part and a second part connected in series. Each of the second resistance element, the third resistance element, and the fourth resistance element is a non-expandable and non-contractable resistance element. The first part and the second part of the first resistance element are provided in different layers of the substrate, overlapped with each other in a length direction in a planar view, and disposed in parallel to each other.

### BRIEF DESCRIPTION OF THE DRAWINGS

FIG. 1 includes a plan view of a detection device according to an embodiment, and an enlarged view of one strain sensor;

FIG. 2 is a plan view schematically illustrating the one strain sensor in FIG. 1;

FIG. 3 is a circuit diagram of the one strain sensor in FIG. 1;

FIG. 4 is a cross-sectional view schematically illustrating the one strain sensor in FIG. 1;

FIG. 5 is a figure explaining a configuration example of an expansion/contraction area;

FIG. 6 is a figure explaining a configuration example of the expansion/contraction area;

FIG. 7 is a schematic view explaining states of a first resistance element;

FIG. 8 is a circuit diagram of the strain sensor for explaining an expansion strain state;

FIG. 9 is a circuit diagram of the strain sensor for explaining a bending strain state; and

FIG. 10 is a block diagram of a detection circuit according to an embodiment.

### DESCRIPTION OF THE PREFERRED EMBODIMENTS

Respective embodiments according to the present disclosure will be hereinafter described with reference to the drawings.

Note that the disclosure will be presented only by way of example. It should be taken as a matter of course that any reasonable modifications easily occurring to those skilled in the art and not departing from the concepts of the present disclosure are included in the claims of the present disclosure. In addition, for more clarification of the description, some of the drawings are presented as schematic illustrations rather than illustrations of actual modes in view of widths, thicknesses, shapes, and the like of respective parts. However, these illustrations are figures only by way of example, and not provided to impose limitations on interpretation of the present disclosure.

Furthermore, some elements included in the present specification and the respective drawings and similar to elements illustrated in the drawings previously referred to and already described will be given identical reference numbers to omit detailed explanation as necessary.

### Embodiment

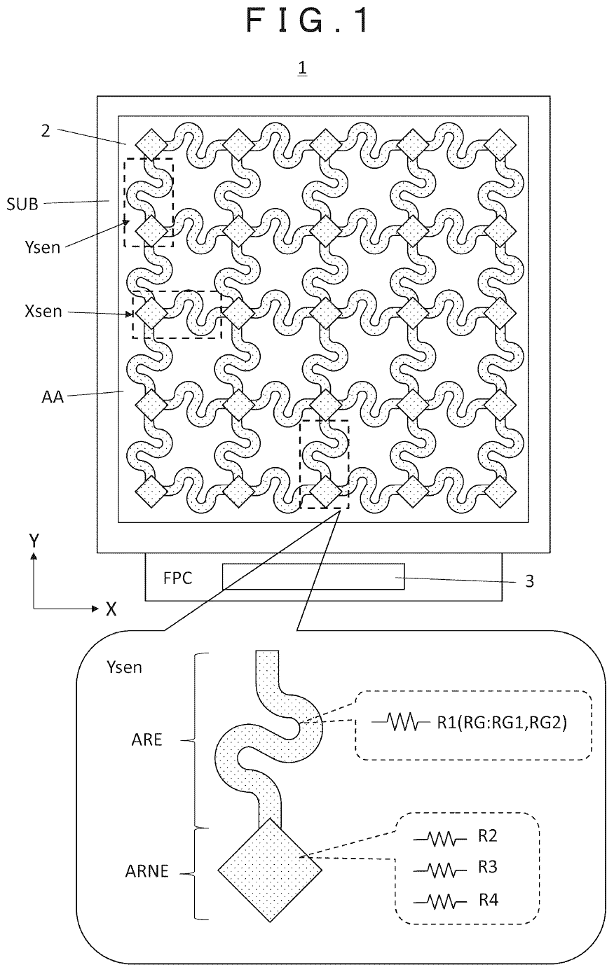

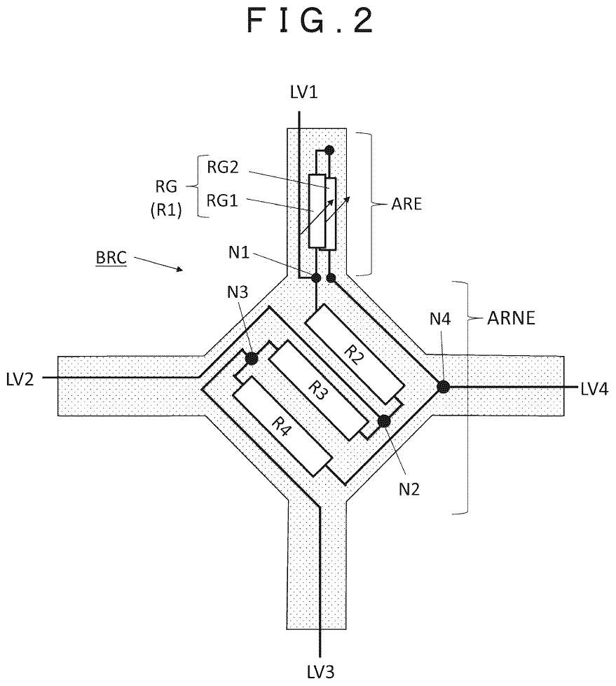

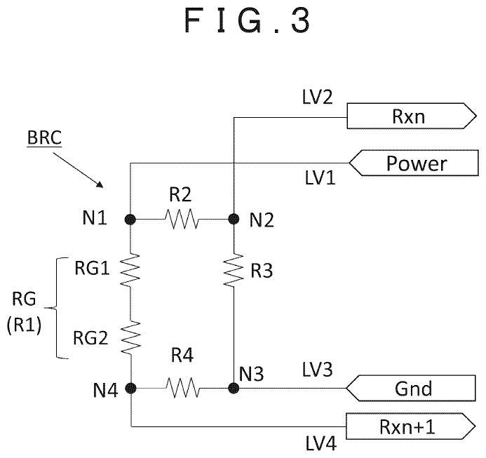

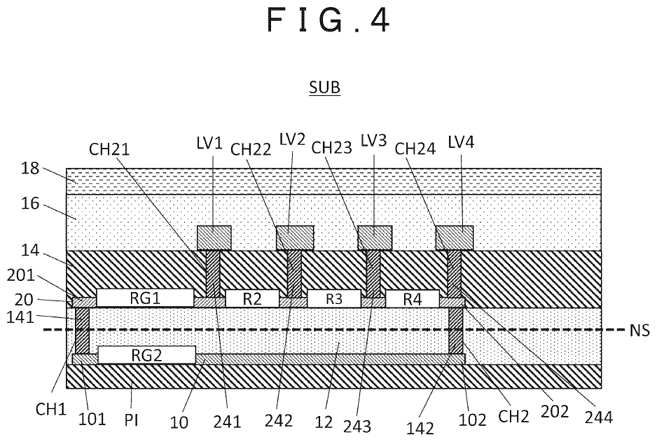

FIG. 1 includes a plan view of a detection device according to an embodiment, and an enlarged diagram of one strain sensor. FIG. 2 is a plan view schematically illustrating the one strain sensor in FIG. 1. FIG. 3 is a circuit diagram of the one strain sensor in FIG. 1. FIG. 4 is a cross-sectional view schematically illustrating the one strain sensor in FIG. 1.

As illustrated in FIG. 1, the detection device 1 includes a support board SUB functioning as a sensor panel, a sensor area 2 disposed on the support board SUB, and a flexible circuit board FPC where a detection circuit 3 is provided. The support board SUB may be also referred to as a sensor board.

The support board SUB includes a substrate which is flexible and has a rectangular shape in a planar view. The support board SUB thus configured is flexibly bendable according to external force, and therefore can tightly be adhered to skin by attachment to a human body (e.g., the back of the hand) at the time of sensing of skin movement. According to this example, the support board SUB has an activated area AA having a rectangular shape, for example. The sensor area 2 is disposed in the activated region AA. The activated area AA is also called an active area AA.

The sensor area 2 includes a plurality of strain sensors sen (Xsen and Ysen) arranged, in a matrix shape, in a first direction X and a second direction Y crossing the first direction X. According to this example, the plurality of strain sensors sen (Xsen and Ysen) include a plurality of first direction sensors Xsen, and a plurality of second direction sensors Ysen. For example, each of the plurality of first direction sensors Xsen is configured to detect expansion and contraction of the support board SUB in the first direction X. For example, each of the plurality of second direction sensors Ysen is configured to detect expansion and contraction of the support board SUB in the second direction Y.

The detection circuit 3 is configured to receive a plurality of detection values which include a plurality of analog sensing signals indicating expansion and contraction of the support board SUB sensed by the plurality of first direction sensors Xsen and the plurality of second direction sensors Ysen. For example, the detection circuit 3 is configured to calculate a plurality of digital sensing data indicating expansion and contraction of the support board SUB on the basis of the plurality of detection values, and output the calculated digital sensing data. Moreover, the detection circuit 3 is configured to calculate a plurality of detection coordinates corresponding to the plurality of digital sensing data as digital coordinate value data, and outputs the calculated digital coordinate value data. In this manner, a host processor HOST having received the plurality of digital sensing data and the plurality of digital coordinate value data can detect movement of skin on the basis of the data associated with expansion and contraction of the support board SUB.

FIG. 1 includes an enlarged view of one of the second direction sensors Ysen. Note that the configuration of the first direction sensor Xsen corresponds to a configuration formed by rotating the configuration of the second direction sensor Ysen clockwise or anti-clockwise by 90 degrees. Accordingly, only the second direction sensor Ysen will be herein explained as a typical example.

The second direction sensor Ysen includes an expansion and contraction area (also referred to as expansion/contraction portion) ARE extending in the second direction Y, and a non-expansion/contraction area (also referred to as non-expansion/contraction portion) ARNE. A longitudinal direction (length direction) of the expansion/contraction area ARE corresponds to the second direction Y for the second direction sensor Ysen, or corresponds to the first direction X for the first direction sensor Xsen. When the support board SUB is expanded in the first direction X or the second direction Y, pulling strain is produced in the expansion/contraction portion ARE formed on the active area AA. Meanwhile, substantially no deformation is produced in the non-expansion/contraction portion ARNE in the first direction X or the second direction Y even when the support board SUB is expanded in the first direction X or the second direction Y.

A gauge resistance element RG constituting a first resistance element R1 is formed in the expansion/contraction area ARE. According to this example, the expansion/contraction area ARE has a bellows-like shape in a planar view. The gauge resistance element RG having the bellows-like shape in a planar view constitutes an expandable and contractable resistance element. The gauge resistance element RG is configured to have a resistance value RG0 when no strain is applied to the expansion/contraction area ARE, i.e., when no strain is applied to the gauge resistance element RG. Meanwhile, when the expansion/contraction area ARE is expanded, i.e., the gauge resistance element RG is expanded, the gauge resistance element RG has a resistance value RG0+ΔR, which is larger than the resistance value RG0 ((RG0+ΔR)>RG0). Conversely, when the expansion/contraction area ARE is compressed, i.e., the gauge resistance element RG is compressed, the gauge resistance element RG has a resistance value RG0−ΔR, which is smaller than the resistance value RG0 ((RG0−ΔR)<RG0).

The non-expansion/contraction area ARNE includes a second resistance element R2, a third resistance element R3, and a fourth resistance element R4 each constituting a bridge circuit BRC in cooperation with the gauge resistance element RG. Each of the second resistance element R2, the third resistance element R3, and the fourth resistance element R4 is considered as a reference resistance element. A resistance value RR0 of each of the second resistance element R2, the third resistance element R3, and the fourth resistance element R4 is set to the same value as the resistance value RG0, where no strain is applied to the gauge resistance element RG formed in the expansion/contraction area ARE (RR0 =RG0).

FIG. 2 is a plan view schematically illustrating the one strain sensor. FIG. 3 is a circuit diagram illustrating the one strain sensor. Note that FIG. 2 schematically illustrates the expansion/contraction area ARE, which actually has a complicated shape of bellows, in a rectangular shape to simplify the figure.

As illustrated in FIGS. 2 and 3, the gauge resistance element RG constituting the first resistance element R1 is formed in the expansion/contraction area ARE. The first resistance element R1 (RG) has a configuration dividable into a first part RG1 and a second part RG2. The first resistance element R1 (RG) is an expandable and contractable resistance element which has the first part RG1 and the second part RG2 connected in series. The first part RG1 and the second part RG2 are provided in different layers of the support board SUB (see FIG. 4), overlapped with each other in the length direction in a planar view, and disposed in parallel to each other.

The second resistance element R2, the third resistance element R3, and the fourth resistance element R4 are formed in the non-expansion/contraction area ARNE. Each of the second resistance element R2, the third resistance element R3, and the fourth resistance element R4 is a non-expandable and non-contractable resistance element.

The first resistance element R1 (RG) constituting the expandable and contractable resistance element has a bellows-like shape in a planar view (see FIG. 1). Each of the second resistance element R2, the third resistance element R3, and the fourth resistance element R4 constituting a non-expandable and non-contractable resistance element has a straight shape (linear shape) in a planar view.

As illustrated in FIGS. 2 and 3, the first resistance element R1 (RG1 and RG2), the second resistance element R2, the third resistance element R3, and the fourth resistance element R4 are connected in series in this order to constitute the bridge circuit BRC in a closed loop shape. The bridge circuit BRC includes first to fourth nodes N1 to N4. The first node N1 is a connection portion between the first resistance element R1 (RG1 and RG2) and the second resistance element R2. The second node N2 is a connection portion between the second resistance element R2 and the third resistance element R3. The third node N3 is a connection portion between the third resistance element R3 and the fourth resistance element R4. The fourth node N4 is a connection portion between the fourth resistance element R4 and the first resistance element R1 (RG1 and RG2).

A first wire LV1 constituting a first power source supply line to which power source potential (Power) is applied is connected to the first node N1, while a third wire LV3 constituting a second power source supply line to which ground potential (Gnd) is applied is connected to the third node N3. In this configuration, predetermined voltage is applied between the first node N1 and the third node N3.

Moreover, a second wire LV2 constituting a signal wire Rxn is connected to the second node N2, a fourth wire LV4 constituting a signal wire Rxn+1 is connected to the fourth node N4, and the detection circuit 3 is connected to the second wire LV2 and the fourth wire LV4. In this configuration, a change in a resistance value of the first resistance element R1 (RG1 and RG2) is detectable by the detection circuit 3.

In other words, the bridge circuits BRC included in a plurality of the strain sensors sen (Xsen and Ysen) of the detection device 1 have at least one first bridge circuit BRC included in the first direction sensor Xsen, and at least one second bridge circuit BRC included in the second direction sensor Ysen. Moreover, the whole first resistance element R1 (RG) of the first bridge circuit has a bellows-like shape extending in the first direction X. Furthermore, the whole first resistance element R1 (RG) of the second bridge circuit has a bellows-like shape extending in the second direction Y different from the first direction X. Note that the signal wires Rxn (LV2) and Rxn+1 (LV4) are independently provided on each of the strain sensors sen (Xsen and Ysen). The first power source supply line (LV1) and the second power source supply line (LV3) may be provided as common lines for each of the strain sensors sen (Xsen and Ysen), or may be independently provided.

The detection device 1 according to the present disclosure includes the bridge circuits BRC each including the resistance element R1 (RG) provided in the expansion/contraction portion ARE, and the three reference resistance elements (R2, R3, and R4) provided in the non-expansion/contraction portion ARNE, and detects a potential difference between both ends of each of the bridge circuits BRC by using an amplifier of the detection circuit 3. The detection device 1 can recognize an expansion/contraction amount of an object on the basis of this potential difference. Moreover, the sensor area 2 according to the present disclosure includes a plurality of the first direction sensors Xsen and a plurality of the second direction sensors Ysen present on the active area AA to function as a biaxial stretchable sensor.

A cross-sectional view of a main part (bridge circuit BRC) of the detection device 1 will be subsequently described with reference to FIG. 4.

As illustrated in FIG. 4, the support board SUB of the detection device 1 includes a base substrate PI made of polyimide resin or the like, and a first wiring layer (RG2, 10) formed on a main surface of the base substrate PI. The first wiring layer (RG2, 10) includes the second part RG2 of the first resistance element R1 (RG), and a first metal wire 10 electrically connected to the second part RG2. Moreover, a first insulation film 12 is formed so as to cover a part of the main surface of the base substrate PI, the second part RG2, and the first metal wire 10. For example, the first insulation film 12 may be made of silicon nitride (SiN).

The first insulation film 12 includes two contact holes CH1 and CH2 formed in the vertical direction. Connection wires 141 and 142 made of metal are embedded inside the contact holes CH1 and CH2, respectively. The connection wires 141 and 142 are electrically connected to the first metal wire 10.

A second wiring layer (RG1, R2, R3, R4, 20) is formed on a main surface of the first insulation film 12. The second wiring layer includes the first part RG1 of the first resistance element R1 (RG), the second resistance element R2, the third resistance element R3, the fourth resistance element R4, and a second metal wire 20.

The first part RG1 of the first resistance element R1 (RG) is provided above the second part RG2. Accordingly, the first part RG1 and the second part RG2 are provided in different layers (wiring layers) of the support board SUB. In addition, the first part RG1 and the second part RG2 are overlapped with each other in the length direction, and disposed in parallel to each other. The second metal wire 20 connects the first part RG1, the second resistance element R2, the third resistance element R3, and the fourth resistance element R4 in series in this order. One end 201 of the second metal wire 20 is electrically connected to one end 101 of the first metal wire 10 via the connection wire 141, while an opposite end 202 of the second metal wire 20 is electrically connected to an opposite end 102 of the first metal wire 10 via the connection wire 142.

In this configuration, the second part RG2 of the first resistance element R1, the one end 101 of the first metal wire 10, the connection wire 141, the one end 201 of the second metal wire 20, the first part RG1 of the first resistance element R1, the second resistance element R2, the third resistance element R3, the fourth resistance element R4, the opposite end 202 of the second metal wire 20, the connection wire 142, and the opposite end 102 of the first metal wire 10 are connected in series in this order to constitute the bridge circuit BRC in a closed loop shape.

A second insulation film 14 is formed on the main surface of the first insulation film 12 in such a manner as to cover the second wiring layer (RG1, R2, R3, R4, 20). The second insulation film 14 includes four contact holes CH21, CH22, CH23, and CH24 formed in the vertical direction. Connection wires 241, 242, 243, and 244 made of metal are embedded inside the contact holes CH21, CH22, CH23, and CH24, respectively. The second metal wire 20 connecting the first part RG1 and the second resistance element R2 corresponds to the first node N1. The connection wire 241 is electrically connected to the first node N1. The second metal wire 20 connecting the second resistance element R2 and the third resistance element R3 corresponds to the second node N2. The connection wire 242 is electrically connected to the second node N2. The second metal wire 20 connecting the third resistance element R3 and the fourth resistance element R4 corresponds to the third node N3. The connection wire 243 is electrically connected to the third node N3. The opposite end 202 of the second metal wire 20 corresponds to the fourth node N4. The connection wire 244 is electrically connected to the fourth node N4.

A third wiring layer (LV1, LV2, LV3, LV4) is formed on a main surface of the second insulation film 14. The first wire LV1 is electrically connected to the connection wire 241. The second wire LV2 is electrically connected to the connection wire 242. The third wire LV3 is electrically connected to the connection wire 243. The fourth wire LV4 is electrically connected to the connection wire 244.

A third insulation film 16 is formed on the main surface of the second insulation film 14 in such a manner as to cover the third wiring layer (LV1, LV2, LV3, LV4). A fourth insulation film 18 constituting a surface protection film is formed on a main surface of the third insulation film 16.

Note herein that the support board SUB of the detection device 1 has following characteristics.
1) The first part RG1 and the second part RG2 of the first resistance element RG have substantially the same length and the same resistance value when the support board SUB is in a flat state (is not bended).
2) The first insulation layer 12 provided between first part RG1 and the second part RG2 of the first resistance element RG has a substantially fixed Young's modulus.
3) A neutral surface NS between the first part RG1 and the second part RG2 is located at a position set within the first insulation film 12. The neutral surface NS is designed to be located at a position away from the first part RG1 and the second part RG2 by substantially the same distance so as to apply substantially the same absolute value of strain to the first RG1 and the second part RG2. Note herein that the neutral surface NS is defined as a surface not either expanded (pulled) or contracted (compressed) before and after a curve of the support board SUB (i.e., a surface producing no strain also after a curve).
4) The first part RG1 and the second part RG2 are provided in different layers of the support board SUB. The first part RG1 and the second part RG2 are overlapped with each other in the length direction in a planar view, and disposed in parallel.
5) The second part RG2 of the first resistance element RG is provided in the first wiring layer.
6) The first part RG1 of the first resistance element RG, the second resistance element R2, the third resistance element R3, and the fourth resistance element R4 are provided in the same layer (second wiring layer).
7) The first wire LV1, the second wire LV2, the third wire LV3, and the fourth wire LV4 are provided in the third wiring layer. The third wiring layer is a wiring layer different from the first wiring layer and the second wiring layer.

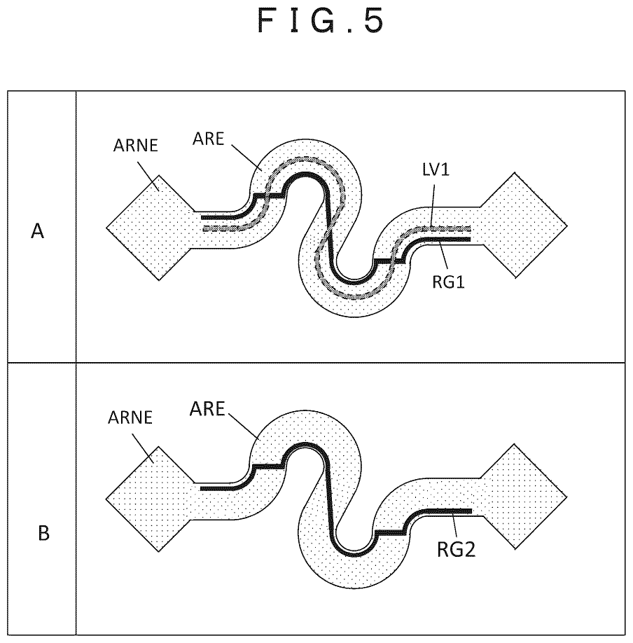

FIG. 5 is a figure explaining a configuration example of the expansion/contraction area ARE. FIG. 5 illustrates an initial state where the expansion/contraction area ARE is not either expanded or compressed (in a flat state or a not bended state). A of FIG. 5 is a plan view illustrating the first part RG1 of the second wiring layer, and the first wire LV1 of the third wiring layer, both formed in the expansion/contraction area ARE. The first part RG1 has a bellows-like shape. B of FIG. 5 is a plan view illustrating the second part RG2 of the first wiring layer formed in the expansion/contraction area ARE. The second part RG2 has a bellows-like shape. The expansion/contraction area ARE illustrated in A of FIG. 5 is stacked on the expansion/contraction area ARE illustrated in B of FIG. 5. Accordingly, the first part RG1 is stacked on the second part RG2 (the first part RG1 is overlapped on the second part RG2). When the expansion/contraction area ARE is not either expanded or compressed, the first part RG1 has the same shape and length as the shape and length of the second part RG2. Accordingly, the first part RG1 and the second part RG2 have the same resistance value.

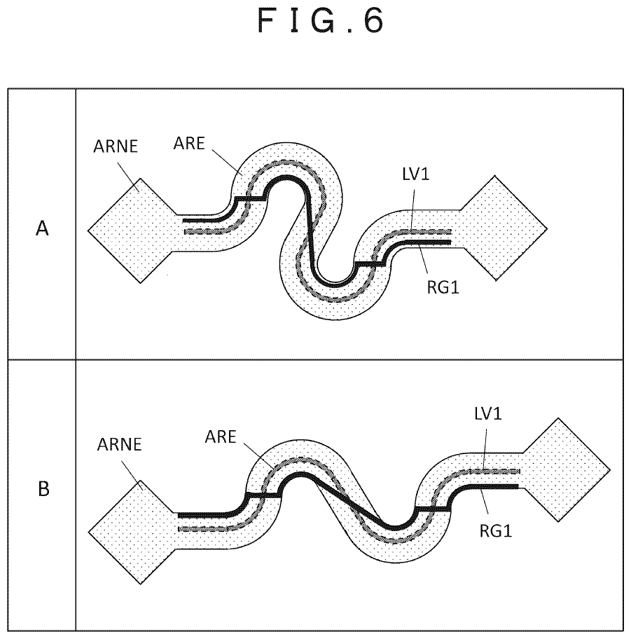

FIG. 6 is a figure explaining a configuration example of the expansion/contraction area ARE. A of FIG. 6 is a figure equivalent to A of FIG. 5, and illustrates an initial state where the expansion/contraction area ARE is not either expanded or compressed. B of FIG. 6 is a figure illustrating an expanded state of the expansion/contraction area ARE. As apparent from the figures, assuming that the resistance value of the first part RG1 in the state of no expansion and no compression of the expansion/contraction area ARE is a value RG01, the resistance value increases from the value RG01 to a value RG01+ΔR according to the expansion of the first part RG1. The first wire LV1 disposed at a central portion of meander wiring is scarcely deformed (the resistance value of the first wire LV1 is not changed) even when the expansion/contraction area ARE is expanded or compressed. Meanwhile, the first part RG1 (or the second part RG2, see B of FIG. 5) disposed close to an end (close to a widthwise end of the wire) of meander wiring is easily deformed when the expansion/contraction area ARE is expanded. Accordingly, the resistance value of the first part RG1 easily changes. In addition, the non-expansion/contraction area ARNE where the second resistance element R2, the third resistance element R3, and the fourth resistance element R4 are disposed is scarcely deformed regardless of the expansion-contraction ratio. Accordingly, in the state of substantially no deformation, the resistance value of each of the second resistance element R2, the third resistance element R3, and the fourth resistance element R4 formed in the non-expansion/contraction area ARNE does not change even when the expansion/contraction area ARE is expanded or compressed.

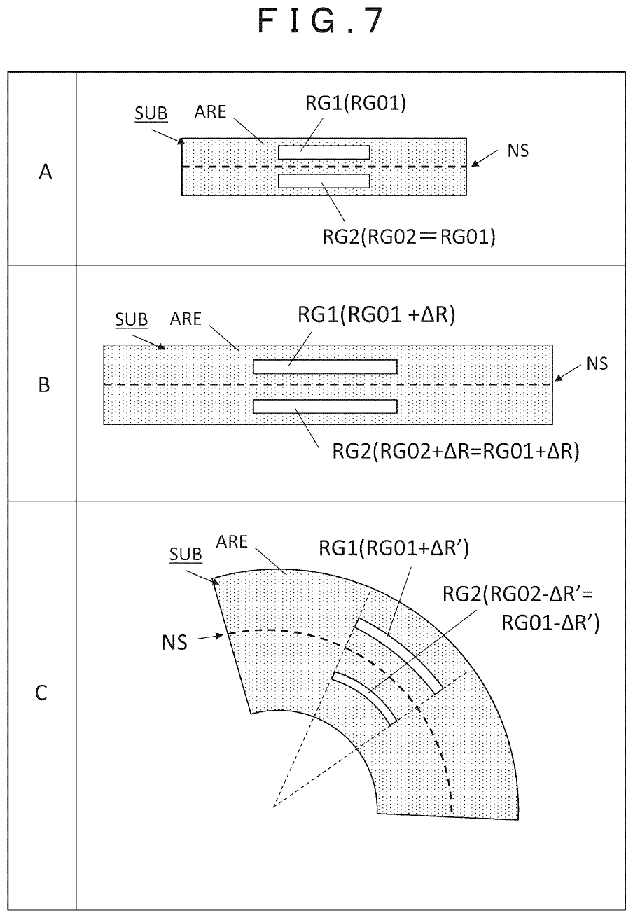

Subsequently described with reference to FIG. 7 will be an initial state, an expansion strain state, and a bending strain state of each of the first part RG1 and the second part RG2 of the first resistance element RG. FIG. 7 is a schematic diagram explaining respective states of the first resistance element RG. FIG. 7 is a cross-sectional view of the first part RG1 and the second part RG2 in the expansion/contraction area ARE in the longitudinal direction, illustrating an initial state A where the expansion/contraction area ARE is not either expanded or compressed, an expansion strain state B where the expansion/contraction area ARE is expanded, and a bending strain state C where the expansion/contraction area ARE is bended.

In the initial state A, the expansion/contraction area ARE is not either expanded or compressed. Accordingly, the lengths and the resistance values of the first part RG1 and the second part RG2 are substantially the same. It is assumed that the resistance values of the first part RG1 and the second part RG2 in this state are RG01 and RG02 (=RG01), respectively. In this state, equal strain is produced in the expansion/contraction area ARE on the upper side and the lower side of the neutral surface NS.

In the expansion strain state B, the expansion/contraction area ARE is expanded. Accordingly, the lengths and the resistance values of the first part RG1 and the second part RG2 are substantially the same. In this case, the resistance value of the first part RG1 is RG01+ΔR, while the resistance value of the second part RG2 is RG02+ΔR (=RG01+ΔR). In this state, equal strain is produced in the expansion/contraction area ARE on the upper side and the lower side of the neutral surface NS.

While not illustrated in the figures, in a compression strain state where the expansion/contraction area ARE is compressed, the lengths and the resistance values of the first part RG1 and the second part RG2 are substantially the same. In this case, the resistance value of the first part RG1 is RG01−ΔR, while the resistance value of the second part RG2 is RG02−ΔR (=RG01−ΔR).

In the bending strain state C, the expansion/contraction area ARE on the upper side of the neutral surface NS is in an expanded state, while the expansion/contraction area ARE on the lower side of the neutral surface NS is in a compressed state. Accordingly, the resistance value of the first part RG1 is RG01+ΔR′, while the resistance value of the second part RG2 is RG02−ΔR′ (=RG01−ΔR′). Assuming that strain of the first part RG1 and strain of the second part RG2 in this state are ε1 and ε2, respectively, ιε1ι=ιε2ι holds.

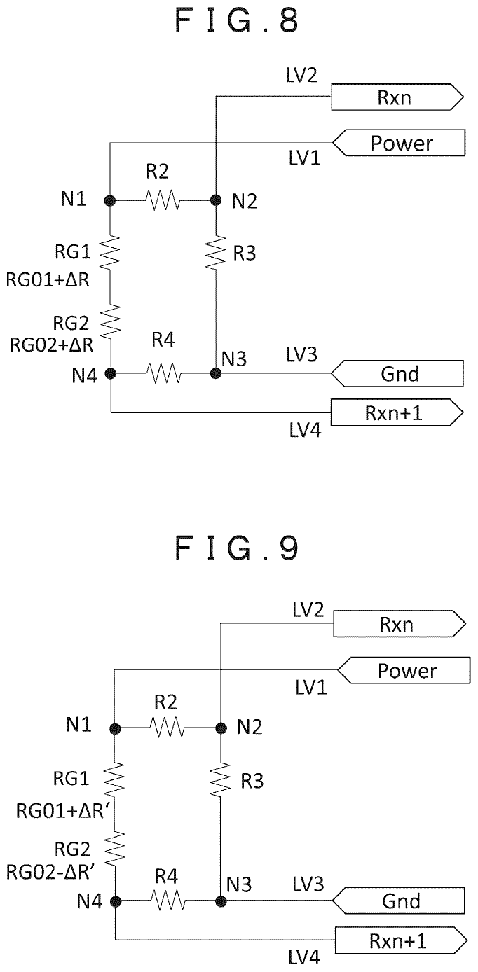

FIG. 8 is a circuit diagram of the strain sensor for explaining the expansion strain state. FIG. 9 is a circuit diagram of the strain sensor for explaining the bending strain state.

As illustrated in FIG. 8, in the expansion strain state, the resistance value of the first part RG1 is RG01+ΔR, and the resistance value of the second part RG2 is RG02+ΔR (=RG01+ΔR). Assuming herein that a resistance value Rr is expressed as (equation 1), a signal VS expressed as (equation 2) is generated.

$$Rr = ( RG θ 1 + Δ R + RG θ 2 + Δ R ) \qquad ( equation 1 )$$

$$VS = Vr \times n - Vrn + 1 = ( Vcc / 2 ) \times ( Δ R / Rr ) \qquad ( equation 2 )$$

In this equation, Vrxn represents voltage of a signal wire Rxn, Vrn+1 represents voltage of a signal wire Rxn+1, and Vcc represents voltage of power source potential (Power). Ground potential (Gnd) is set to 0 V.

While the expansion strain state is explained herein, (equation 2) is also available for the contraction strain state (compression).

As illustrated in FIG. 9, in the bending strain state, the resistance value of the first part RG1 is RG01+ΔR, and the resistance value of the second part RG2 is RG02−ΔR (=RG01−ΔR). Accordingly, signals having different polarities are recognized at the time of bending. In this case, the following signal potential VS is generated.
VS=0

As apparent from above, bending strain is cancelled by the connection of the bridge circuit BRC in the manners described in FIGS. 3, 8, and 9 for each of the arranged nodes of the respective strain sensors (Ysen and Xsen). Accordingly, only expansion/contraction strain (expansion strain and contraction strain) is accurately detectable.

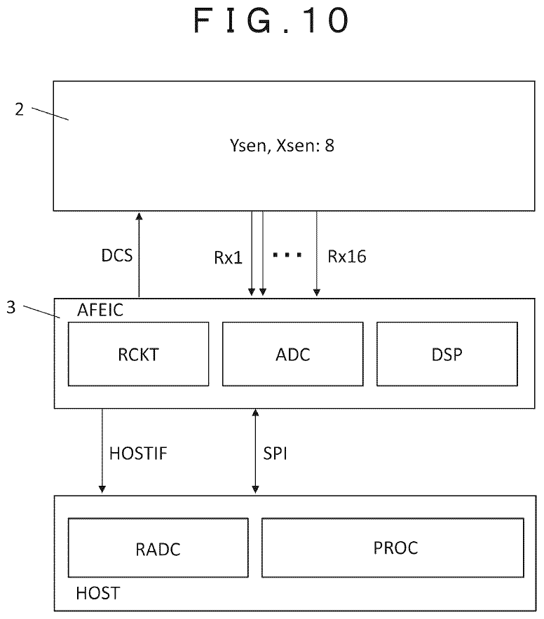

FIG. 10 is a block diagram of the detection circuit according to an embodiment. Described herein by way of example is a case where the sensor area 2 includes the eight strain sensors sen (Xsen and Ysen), for example. In this case, the detection circuit 3 includes an analog front-end circuit (AFEIC) to which sixteen signal wires Rx1 to Rx16 are connected as signal wires Rx extending from the eight strain sensors sen. The AFEIC converts sixteen analog detection signals detected by the strain sensors sen for each frame into digital signals, and transmits the digital signals to a host device HOST.

The AFEIC includes a read out circuit RCKT which generates power source potential (Power), ground potential (Gnd), and driving control signals DCS such as timing signals to read the eight strain sensors sen for each frame, an analog-digital conversion circuit ADC which converts analog detection signals read via the signal wires Rx1 to Rx16 into digital data, and a digital signal processor DSP which performs processing such as filtering for the digital data.

The host device HOST includes a data receiving circuit which receives digital data (Raw data) read from the AFEIC via a host interface HOSTIF, and an arithmetic processing circuit PROC which performs data shaping and coordinate calculation on the basis of the received digital data to calculate expansion and contraction of an object to be measured. Each of the host device HOST and the AFEIC may be configured to further establish interdevice communication by using a serial peripheral interface SPI.

All possible detection devices developed by those skilled in the art with appropriate design modifications on the basis of the detection device described above as the embodiments of the present disclosure belong to the scope of the present disclosure as long as the concepts of the present disclosure are contained in the detection devices thus developed.

It should be understood that various modified examples and corrected examples which can occur to those skilled in the art within the scope of the spirit of the present disclosure also belong to the scope of the present disclosure.

For example, any additions, deletions, or design changes of constituent elements, or additions, omissions, or condition changes in steps made by those skilled in the art as necessary for the respective embodiments described above are included in the scope of the present disclosure as long as the concepts of the present disclosure are included in the modifications.

Moreover, it should be understood that other operational advantages that are offered by the modes described in the present embodiment and apparent from the description of the present specification, or reasonably occur to those skilled in the art can be obviously produced by the present disclosure.

Various types of disclosure can be created by appropriately combining a plurality of constituent elements disclosed in the above embodiments. For example, some constituent elements may be eliminated from all constituent elements presented in the embodiments. In addition, constituent elements associated with different embodiments may be appropriately combined.

What is claimed is:

1. A detection device comprising:
a substrate that is flexible; and
a bridge circuit disposed within the substrate, wherein
a first resistance element, a second resistance element, a third resistance element, and a fourth resistance element are connected in series in an order from the first to fourth resistance elements to constitute the bridge circuit in a closed loop shape,
the first resistance element is an expandable and contractable resistance element that has a first part and a second part connected in series,
each of the second resistance element, the third resistance element, and the fourth resistance element is a non-expandable and non-contractable resistance element, and
the first part and the second part of the first resistance element are provided in different layers of the substrate, overlapped with each other in a length direction in a planar view, and disposed in parallel to each other.

2. The detection device according to claim 1, wherein
an insulation layer provided between the first part and the second part of the first resistance element has a substantially fixed Young's modulus.

3. The detection device according to claim 1, wherein
the first part and the second part of the first resistance element have substantially an equal length and an equal resistance value when the substrate is in a flat state.

4. The detection device according to claim 1, wherein
the first part of the first resistance element, the second resistance element, the third resistance element, and the fourth resistance element are provided in an identical layer.

5. The detection device according to claim 1, wherein
the expandable and contractable resistance element has a bellows-like shape, and
the non-expandable and non-contractable resistance element has a straight shape.

6. The detection device according to claim 1, wherein
assuming that a connection portion between the first resistance element and the second resistance element is a first node, that a connection portion between the second resistance element and the third resistance element is a second node, that a connection portion between the third resistance element and the fourth resistance element is a third node, and that a connection portion between the fourth resistance element and the first resistance element is a fourth node, predetermined voltage is applied to a power source supply line connected between the first node and the third node, and
a detection circuit is connected to the second node and the fourth node.

7. The detection device according to claim 6, wherein
the second part of the first resistance element is formed in a first layer included in the substrate,
the first part of the first resistance element is formed in a second layer included in the substrate and different from the first layer, and
the power source supply line connected to the first node and the third node, and a signal wire connected to the detection circuit connected to the second node and the fourth node are formed in a third layer different from the first layer and the second layer.

8. The detection device according to claim 1, wherein
a plurality of the bridge circuits are provided and disposed in a matrix shape in a planar view.

9. The detection device according to claim 1, wherein
the bridge circuit includes
at least one first bridge circuit, and
at least one second bridge circuit,
the whole first resistance element of the first bridge circuit has a bellows-like shape extending in a first direction, and
the whole first resistance element of the second bridge circuit has a bellows-like shape extending in a second direction different from the first direction.
